(19) United States
(12) Patent Application Publication
(10) Pub. No.: US 2017/0214181 A1
(43) Pub. Date: Jul. 27, 2017

(54) JACK MODULE BLOCK-OUT DEVICE

(71) Applicant: YOU HUNG INTERNATIONAL CO., LTD., NEW TAIPEI CITY (TW)

(72) Inventor: TZU-RUNG TSAY, NEW TAIPEI CITY (TW)

(21) Appl. No.: 15/370,323

(22) Filed: Dec. 6, 2016

(30) Foreign Application Priority Data
Jan. 26, 2016 (TW) 105201177

(51) Int. Cl. H01R 13/639

(52) U.S. Cl. CPC H01R 13/6397

(57) ABSTRACT

A jack module block-out device includes a lock and a key. The locker has a hollow housing in a shape corresponding to a socket of a cable port for engagement, a locker hole at a front surface thereof and a latch body connecting to a rear edge of the housing and having a front edge extending and forming a displaceable piece arranged at an acute angle. The displaceable piece further has a front surface and a holding section with a block facing toward an inner end of the locker hole. The key has its front end arranged corresponding to the shape of the locker hole to be inserted therein and turned for unlocking. An eccentric block is further arranged corresponding to the block on the displaceable piece to remove the locker together from the socket of the cable port.

### BACKGROUND OF THE INVENTION

1. Field of the Invention

The present invention relates to a jack module block-out device, particularly to one that can be unlocked from a cable port by a key.

2. Description of the Related Art

Nowadays internet networks have been widely applied in information transfer. Such networks mainly rely on the Ethernet networks for rapid and stable transfer, and are suitable in many industries such as the government, the police, the military, and business companies; however, such technology also allows unauthorized users to have access to the information and data easily, leaving uncertainties in information security.

There are various locks designed for such problem in the markets. For example, a block-out cover and a removal tool are disclosed in U.S. Pat. No. 8,202,110. The device covers jack modules to prevent from undesirable entry, and further has a tool to remove the cover from the jack modules. The removal tool is a tweezer that engages the cover and removes it by clamping and pulling. Such operation could damage the device with improper pulling angle and pulling forces; also, it may be unsmooth once a minor damage is done.

### SUMMARY OF THE INVENTION

A primary object of the present invention is to provide a jack module block-out device that ensures more of accessibility to data via the internet networks by having a cable port to be locked by a locker and to be unlocked by a key smoothly.

To achieve the objects mentioned above, the present invention mainly comprises a locker and a key.

The locker comprises a hollow housing arranged in a shape corresponding to a socket of a cable port for engagement and having a locker hole on a front surface thereof, a latch body having a rear side linking to a rear surface of the housing and a displaceable piece arranged at a front of said latch body at an acute angle, forming a holding section, said displaceable piece facing toward an inner end of the locker hole and further having a block at a bottom thereof aligning the locker hole; and the key has a front end thereof arranged in a shape corresponding to the locker hole for engagement and turning therein, and an eccentric block arranged at the front end corresponding to the block of the displaceable piece.

Whereby upon the locker engaging the socket of the cable port, the holding section is abutting on a staircase edge of the cable port and locking up the socket, and then upon the key being inserted into the locker hole and turned for unlocking, the eccentric block is pressing the block of the displaceable piece downwards for the displaceable piece to displace downwards, resulting in the holding section displacing downwards from the staircase edge for the locker to be removed from the socket, therefore unlocking the cable port.

Furthermore, the key has an aligning section at a middle section thereof corresponding to a reference portion arranged on the housing right above the locker hole for alignment when inserting the key, and the key further has a protrusion at one side thereof for recognition in the operation.

With structures disclosed above, the present invention has the eccentric block to remove the locker therewith from a cable port for which to be accessible for information and data via the internet connection. The device is therefore safer than a conventional lock unlocked by a tweezer with easier operation and less possibility of damages.

### BRIEF DESCRIPTION OF THE DRAWINGS

FIG. 1A is an exploded view of the present invention in a preferred embodiment;

FIG. 1B is a sectional view of the present invention in a preferred embodiment without engagement of elements thereof;

FIG. 2A is a perspective view of the present invention in a preferred embodiment;

FIG. 2B is a sectional view of the present invention in a preferred embodiment with a locker thereof locking up a socket of a cable port;

FIG. 3A is a perspective view of the present invention in a preferred embodiment, showing the locker locking up the cable port;

FIG. 3B is a sectional view of the present invention in a preferred embodiment, showing the locker locking up the cable port;

FIG. 4A is a perspective view of the present invention in a preferred embodiment, showing the locker being unlocked from the cable port; and

FIG. 4B is a sectional view of the present invention in a preferred embodiment, showing the locker being unlocked from the cable port.

### DETAILED DESCRIPTION OF THE PREFERRED EMBODIMENT

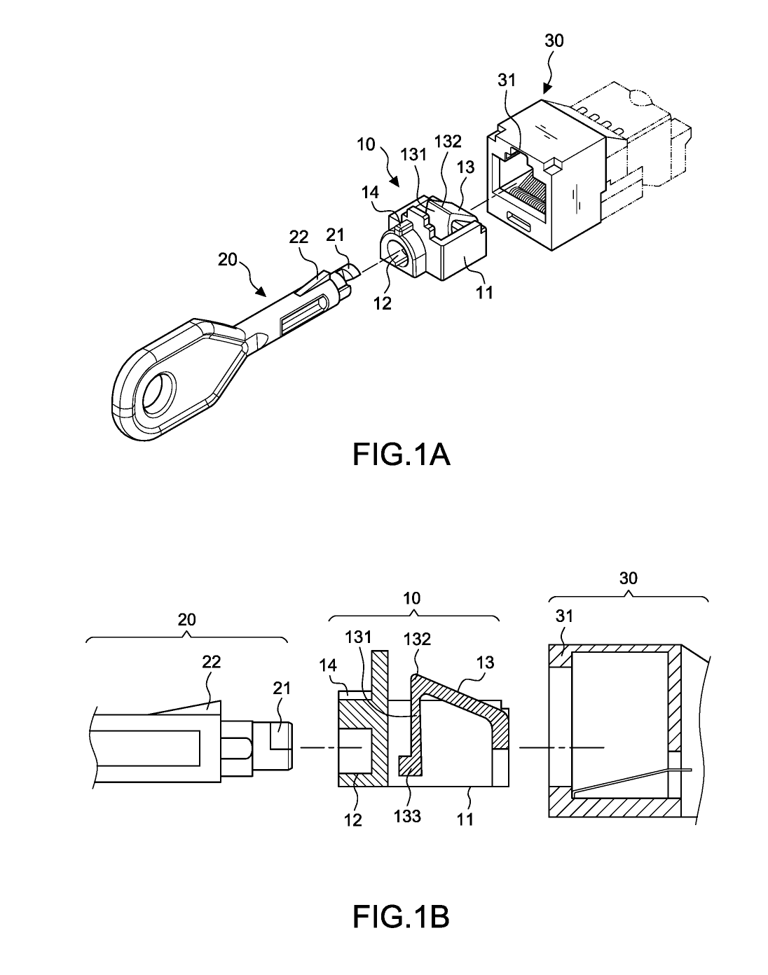

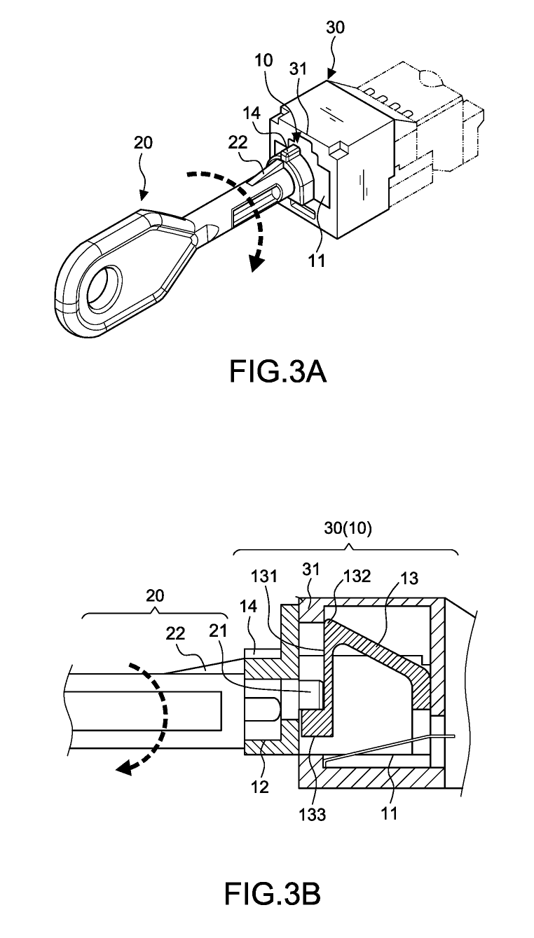

Referring to FIGS. 1A-4B, a preferred embodiment of the present invention mainly comprises a locker 10 and a key 20 for the locker 10.

The locker includes a hollow housing 11, a locker hole 12 and a latch body 13. The housing 11 is arranged in a shape corresponding to a socket of a cable port 30 for engagement. The locker hole 12 is arranged on a front surface of the housing 11, and the latch body 13 has a rear side thereof linking to a rear surface of the housing 11 and a displaceable piece 131 arranged at a front of the latch body 13 at an acute angle, forming a holding section 131; the displaceable piece 131 is facing toward an inner end of the locker hole 12 and further has a block 133 at a bottom thereof aligning the locker hole 12.

The key 20 has a front end thereof arranged in a shape corresponding to the locker hole 12 for engagement and turning therein and an eccentric block 21 arranged at the front end corresponding to the block 133 of the displaceable piece 131 as shown in FIGS. 1A and 1B.

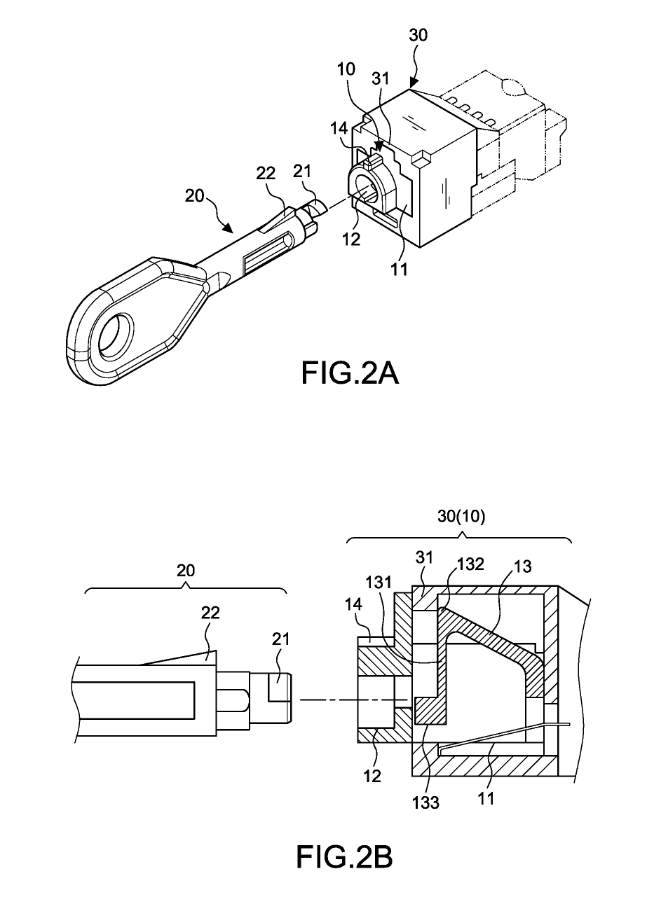

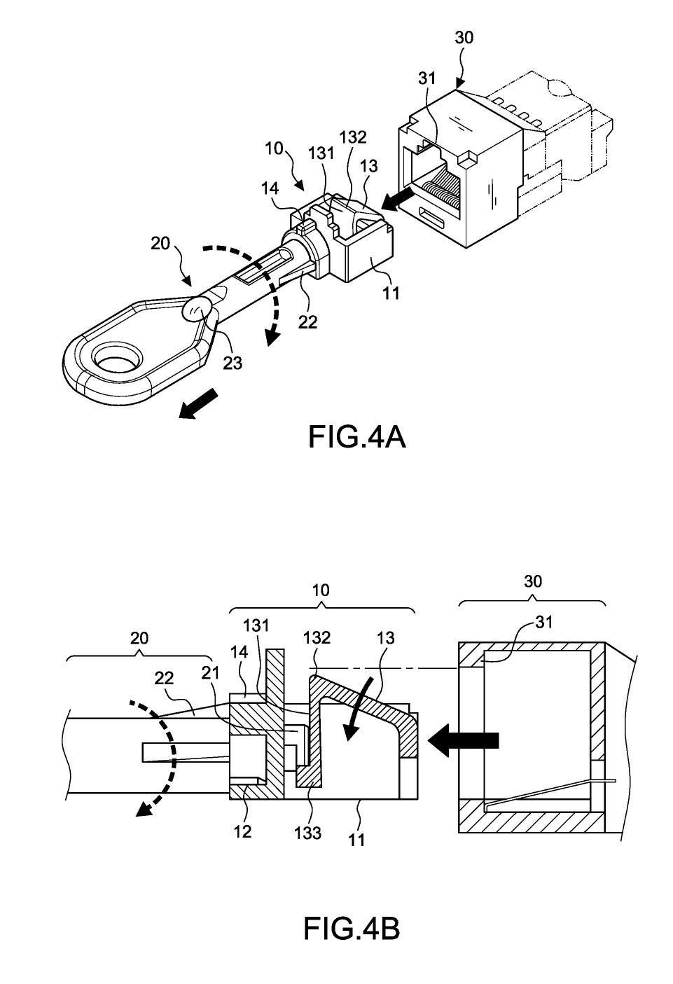

Further referring to FIGS. 2A and 2B, when the locker 10 is engaging the socket of the cable port 30, the holding section 131 is abutting on a staircase edge 31 of the cable port 30 and locking up the socket. Then referring to FIGS. 2A and 2B, when the key 120 is inserted into the locker hole 12 and turned for unlocking, the eccentric block 21 is pressing the block 133 of the displaceable piece 131 downwards for the displaceable piece 131 to displace downwards, causing the holding section 132 displacing downwards from the staircase edge 31 for the locker 10 to be removed from the socket and unlocking the cable port 30. Then the locker 10 is removed from the cable port 30 together with the key 20 as shown in FIGS. 4A and 4B.

The key 20 further has an aligning section 22 at a middle section thereof corresponding to a reference portion 14 arranged on the housing 11 right above the locker hole 12 for alignment when inserting the key 20. When the key 20 is turned for unlocking, the aligning section 22 would rotate an angle from the reference portion 14 and therefore removing the locker 10 by the eccentric block 21. Also, the key 20 has a protrusion 23 at one side thereof for recognition so that its user can perform the unlocking simply with the position of the protrusion 23, featuring the present invention as foolproof. In the embodiment, the protrusion 23 can be a solid block or linear protrusion.

In short, the present invention has the eccentric block 21 to remove the locker 10 together with the key 20 to unlock the cable port 30, which is comparatively safer and easier than a conventional device that has a tweezer as a removal tool to take out a locker device. More importantly, with such structures, the present invention is able to avoid damages caused by conventional devices.

Although particular embodiment of the invention has been described in detail for purposes of illustration, various modifications and enhancements may be made without departing from the spirit and scope of the invention. Accordingly, the invention is not to be limited except by the appended claims.

What is claimed is:

1. A jack module block-out device, including a locker and a key, said locker comprising:
a hollow housing arranged in a shape corresponding to a socket of a cable port for engagement and having a locker hole on a front surface thereof, a latch body having a rear side linking to a rear surface of the housing and a displaceable piece arranged at a front of said latch body at an acute angle, forming a holding section, said displaceable piece facing toward an inner end of the locker hole and further having a block at a bottom thereof aligning the locker hole; and
said key having a front end thereof arranged in a shape corresponding to the locker hole for engagement and turning therein, and an eccentric block arranged at the front end corresponding to the block of the displaceable piece;
whereby upon the locker engaging the socket of the cable port, the holding section is abutting on a staircase edge of the cable port and locking up the socket, and then upon the key being inserted into the locker hole and turned for unlocking, the eccentric block is pressing the block of the displaceable piece downwards for the displaceable piece to displace downwards, resulting in the holding section displacing downwards from the staircase edge for the locker to be removed from the socket, therefore unlocking the cable port.

2. The jack module block-out device as claimed in claim 1, wherein the key has an aligning section at a middle section thereof corresponding to a reference portion arranged on the housing right above the locker hole for alignment when inserting the key.

3. The jack module block-out device as claimed in claim 1, wherein the key further has a protrusion at one side thereof for recognition when being inserted into the locker hole.
